(19) United States
(12) Patent Application Publication
(10) Pub. No.: US 2002/0154632 A1
(43) Pub. Date: Oct. 24, 2002

(54) Method and apparatus for switching between multiple SIM cards within a mobilephone

(75) Inventors: Yung-Feng Wang, Taipei Hsieng (TW); Kun-Huei Chen, Taipei Hsieng (TW)

Correspondence Address: BIRCH STEWART KOLASCH & BIRCH, PO BOX 747, FALLS CHURCH, VA, 22040-0747, US

(73) Assignee: Inventec Corporation

(21) Appl. No.: 09/887,977

(22) Filed: Jun. 22, 2001

(30) Foreign Application Priority Data
Apr. 23, 2001 (TW) 90109636

(51) Int. Cl. H04L 12/28

(52) U.S. Cl. 370/389; 370/466

(57) ABSTRACT

The present invention provides a method for switching between multiple SIM cards within a telephone. The method comprises the steps of storing a plurality of internal ID codes, each of which identifies a direct service provider of one of the SIM cards, receiving an ID code identifying one of the service providers, comparing the received ID code to each of the internal ID codes, and switching to one of the SIM cards when the service provider identified by the received ID code is recognized as the direct one of the SIM card switched to, identified by the corresponding internal ID code.

### BACKGROUND OF THE INVENTION

1. Field of the Invention

The present invention relates to an apparatus and method for switching between multiple Subscriber Identity Module (SIM) cards suitable for international roaming.

2. Description of the Prior Art

Mobile phones are a very popular electronic product for personal communication. Mobile phones use SIM cards to connect users with the service provider who issued the card. Communication is intermediated by the SIM card's direct service provider. When the mobile phone is outside the effective range of a direct provider and within the effective range of another co-operative provider, i.e. the local provider switches from direct access to access provided by a co-operator, communication is now intermediated by the direct provider as well as the local provider compatible with the SIM card; and co-operates with the direct provider. People often make calls using international roaming while abroad, a kind of service provided by the cooperation of direct and other service providers.

Frequent users often have several SIM cards alternately inserted into their mobile phones for access to the telecommunication services of local providers in different areas when traveling abroad. Thus, they can avoid making international roaming calls by switching to the SIM card of the local service provider when making calls in that zone. However, expensive international roaming calls cannot be avoided when no SIM cards are available that are supported by the local provider. In such a situation it is important to switch to a SIM card achieving the least expensive connection path to the destination when making a call. For example, a mobile phone user has four SIM cards T, U, J and F in hand, from providers T in Taiwan, U in USA, J in Japan and F in France respectively. Each of the four direct providers cooperates with a provider G in Germany, i.e. the four SIM cards are compatible with the provider G. The user lives in USA and usually keeps the U card inserted into his mobile phone. In the USA, U is the direct provider for him when he makes calls. On a business trip, he first travels to Taiwan. The local provider switches from provider U to provider T. Therefore, he inserts the T card into his mobile phone when he makes calls. He then travels to Germany. He does not have a SIM card from the local provider G in Germany. Therefore, he inserts the F card when making a call to a friend in Germany and inserts the U card when making a call to his family in USA. The F card achieves the least expensive (shortest) connection path among all possible paths for a call to Germany, as does the U card for a call to USA.

Conventionally, the mobile phone user switches SIM cards by first turning off the power, removing the battery, then pulling out the old card and finally inserting a new card. The switching of the SIM cards is, of course, troublesome. Furthermore, the different fee rates charged under the cooperation of the various providers for the SIM cards are extremely complex.

### SUMMARY OF THE INVENTION

The object of the present invention is to provide an easier apparatus and method for switching between multiple SIM cards within a telephone by which a user can always switch to a SIM card achieving the least expensive connection path for each call.

To achieve the above-mentioned object, the present invention provides a method for switching between multiple SIM cards within a telephone. The method comprises the steps of storing a plurality of internal ID codes, each of which identifies a direct service provider of one of the SIM cards, receiving an ID code identifying one of the service providers, comparing the received ID code to each of the internal ID codes, and switching to another SIM card when the service provider identified by the received ID code is recognized as another provider.

The present invention further provides an apparatus for switching between multiple SIM cards within a telephone, the apparatus comprising a storage device, a receiver, a processor and a switch. The storage device stores a plurality of internal ID codes, each of which identifies a direct service provider of one of the SIM cards. The receiver receives an ID code identifying one of the service providers. The processor compares the received ID code to each of the internal ID codes. The switch switches to one of the SIM cards when the service provider identified by the received ID code is recognized as the direct provider of the SIM cards switched to.

In the present invention, the processor compares the ID codes identifying the local service provider and the direct service provider of the SIM cards, and the storage device stores a priority table of their cooperations, whereby the mobile phone can automatically switch to a SIM card achieving the least expensive connection path for each call.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a block diagram of a mobile phone according to one embodiment of the invention.

FIG. 2 is a diagram showing the switching operation according to one embodiment of the invention.

FIG. 3 is a flow chart of the operation of the mobile phone according to one embodiment of the invention.

FIG. 4 is a priority table stored in the mobile phone according to one embodiment of the invention.

FIG. 5 is a flow chart of the method for switching between multiple SIM cards within a mobile phone according to one embodiment of the invention.

### DETAILED DESCRIPTION OF THE INVENTION

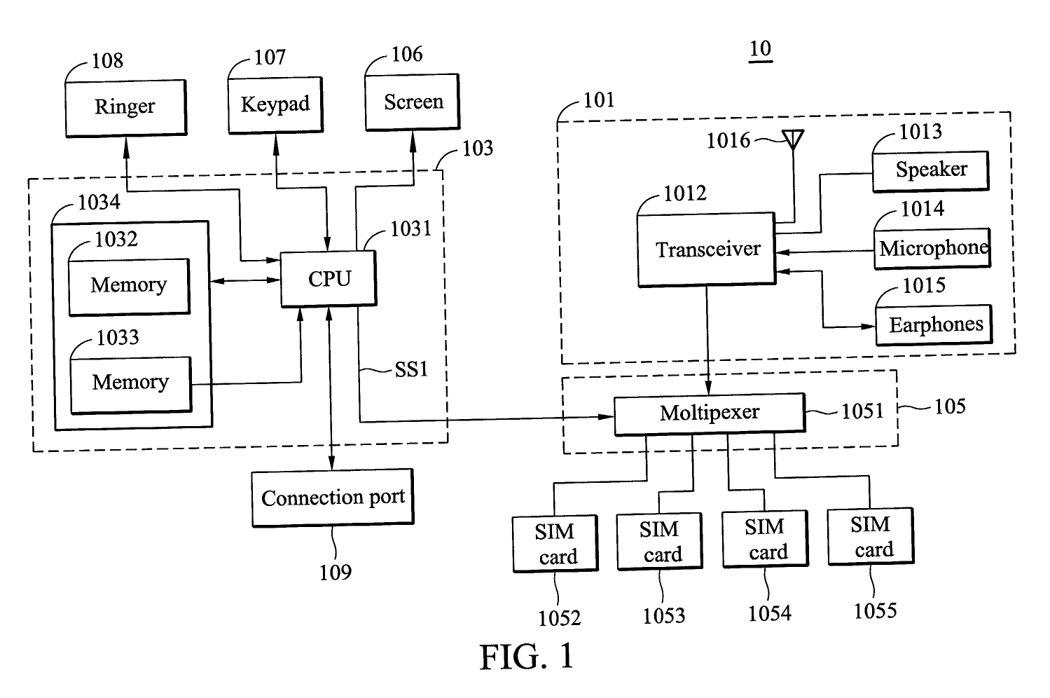

FIG. 1 is a block diagram of a mobile phone according to one embodiment of the invention.

A mobile phone 10 comprises a receiver 101, processor 103, switch 105, a screen 106, a keypad 107, a ringer 108, a connection port 109 and SIM cards 1052-1055. The receiver 101 comprises a transceiver 1012, a speaker 1013, a microphone 1014, an earphones 1015 and an antenna 1016. The processor 103 comprises a CPU 1031, and a storage device 1032 having a memory 1033 storing ID codes identifying the direct service providers of the SIM cards 1052-1055 and a memory 1034 storing a priority table. The switch 105 is a multiplexer 1051.

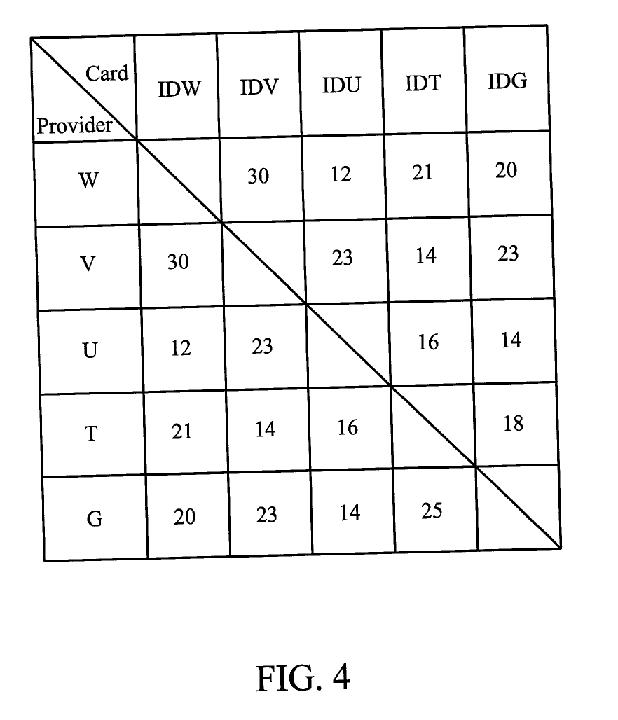

FIG. 4 is a priority table stored in the memory 1034 in FIG. 1 The priority table shows each fee rate under cooperation between one SIM card with one compatible service provider in US cents per second when the destination of a call is determined. For example. The fee rate under the cooperation of the card IDV with the provider T is 14 cents/second.

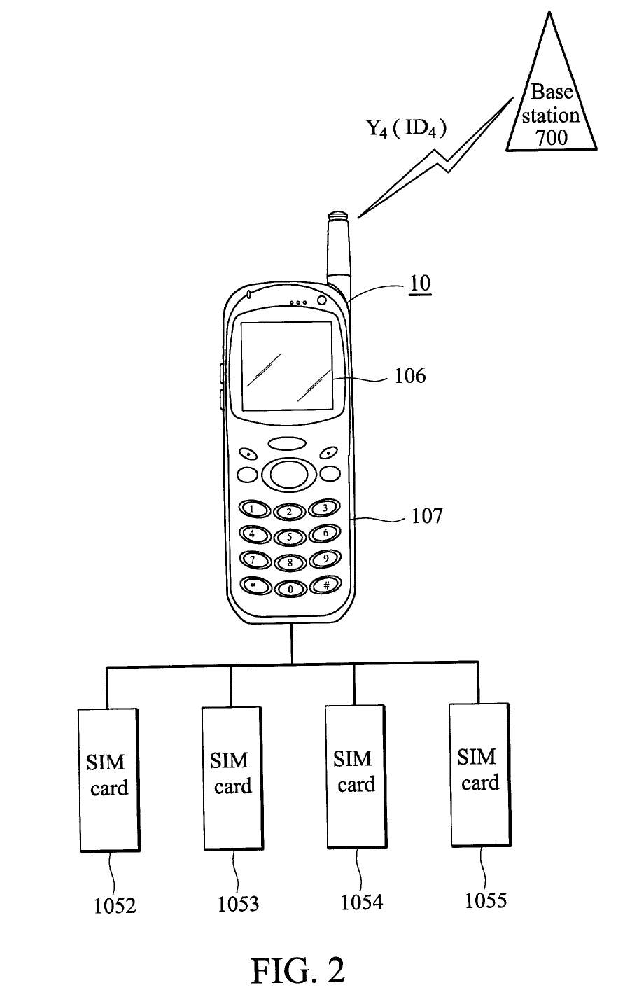

Please refer to FIG. 2 together with FIG. 1. A base station 700 of a local telecommunication service provider communicates with the mobile phone 10 through a radio signal Y4 received by the antenna 1016. The radio signal Y4 carries an ID code ID4 identifying the local telecommunication service provider. The CPU 1031 is connected to the receiver 101 for reading the ID code ID4 and then comparing it to each of the ID codes stored in the memory 1033. When the service providers identified by the ID codes in comparison are the same, i.e. the service provider identified by the ID code ID4 is recognized as one of the direct providers of the SIM cards, the CPU 1031 makes the switch 105 switching the SIM card to that of the service provider identified by the ID code ID4 through a signal SS1. When any two of the service providers identified by the ID codes in comparison are not the same, i.e. the service provider identified by the ID code ID4 is recognized as only a compatible provider of the SIM cards, and the destination of a call is determined, the CPU 1031 looks up the priority table stored in memory 1034 to determine a cooperation achieving the least expensive connection path and then makes the switch 105 switching the SIM card to the one achieving the least expensive connection path with the local service provider through the signal SS1. Please refer to FIG. 4. for example, the four SIM cards are card IDW, IDV, IDU and IDT respectively. When the local service provider is provider T, the CPU 1031 makes the switch 105 switching the SIM card to the card IDT. When the local service provider is provider G and the destination of a call is determined, the CPU 1031 checks the table to determine that the card IDU has the lowest fee rate among the other cards IDW, IDV and IDT and then makes the switch 105 switching the SIM card to the card IDU.

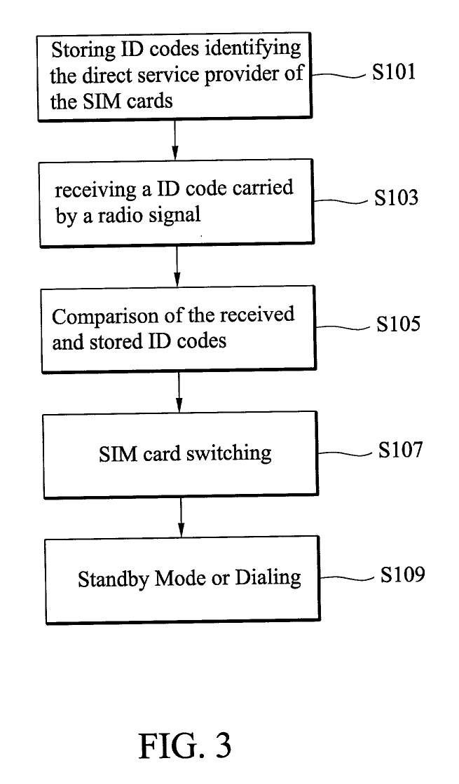

FIG. 3 is a flow chart of the operation of the mobile phone 10.

First, in step S101, the mobile phone 10 stores the ID codes identifying the direct service provider of the SIM cares 1052-1055.

Next, in step S103, the mobile phone 10 receives the radio signal Y4 transmitted from the base station 700 of the local service provider by the receiver 101 and then gets the ID code ID4 carried by the radio signal Y4.

Then, in step S105, the CPU sends out the signal SS1 to the switch 105 according to the result of the comparison of the ID codes or the determination after checking the priority table.

Further, in step S107, the switch 105 receives the signal SS1 and switches SIM cards according to the signal SS1.

Finally, the mobile phone 10 activates a Standby Mode if the switching is carried out immediately after the mobile phone is turned on, or begins to dial if the switching is carried out immediately after dialing, i.e. a send key is pressed.

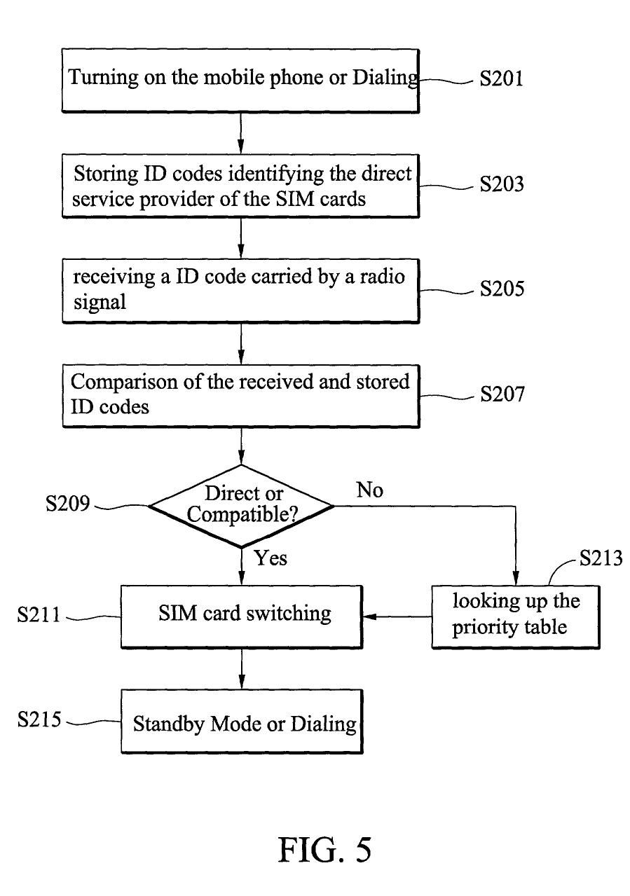

FIG. 5 is a flow chart of the method for switching between multiple SIM cards within a mobile phone according to one embodiment of the invention.

In step S201, the switching of the SIM cards is activated immediately after the mobile phone is turned on or a Send key is pressed for a dial.

In step S203, the mobile phone stores the ID codes identifying the service providers of the SIM cards.

In step S205, the mobile phone receives the radio signal transmitted from a base station of the local service provider and then gets an ID code carried by the radio signal and identifying the local service provider.

In step S207, the mobile phone compares the received ID code to each of the stored ID codes.

In step S209, the mobile phone determines if any of the service providers identified by the stored ID codes is the same as the one identified by the received code. If it is, i.e. the service provider identified by the received ID code is recognized as one of the direct providers of the SIM cards, step S211 is carried out. If it is not, i.e. the service provider identified by the received ID code is cecognized as only a compatible provider of the SIM cards, step S209 is carried out.

In step S213, the mobile phone checks a priority table comprising each fee rate under cooperation with one SIM card with one compatible service provider and then determines the SIM card having the lowest fee rate.

In step S211, the mobile phone switches to a SIM card according to the result of the comparison of the ID codes or the determination after checking the priority table.

In step S215, the mobile phone activates a Standby Mode if the switching is carried out immediately after the mobile phone is turned on, or begins to dial if the switching is carried out immediately after dialing, i.e. a Send key is pressed.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for switching between multiple SIM cards within a telephone, comprising the steps of:
storing a plurality of internal ID codes, each of which identifies a direct service provider of one of the SIM cards;
receiving an ID code identifying one of the service providers;
comparing the received ID code to each of the internal ID codes; and
switching to one of the SIM cards when the service provider identified by the received ID code is recognized as the direct provider of the SIM card switched to, identified by the corresponding internal ID code.

2. The method as claimed in claim 1 wherein the internal ID codes further identify a provider compatible with the direct providers of the SIM cards.

3. The method as claimed in claim 2 further comprising the steps of:
storing a priority table comprising priorities of cooperation for the SIM cards with the compatible service provider; and
switching to one of the SIM cards according to the priorities when the service provider identified by the received ID code is recognized as the compatible one of the SIM card switched to, identified by the corresponding internal ID code.

4. The method as claimed in claim 3 wherein the priorities correspond to fee rates under the cooperation for the SIM cards with the compatible service provider and the fee rate of the cooperation for the SIM card switched to with the compatible service provider is the lowest.

5. The method as claimed in claim 1 further comprising the step of:
activating a Standby mode on the telephone.

6. The method as claimed in claim 1 wherein the switching of the SIM cards is activated immediately after the telephone is turned on.

7. The method as claimed in claim 1 wherein the switching of the SIM cards is activated immediately after an Send key of the telephone is pressed.

8. An apparatus for switching between multiple SIM cards within a telephone, the apparatus comprising:
a storage device storing a plurality of internal ID codes, each of which identifies a direct service provider of one the SIM cards;
a receiver receiving an ID code identifying one of the service providers;
a processor comparing the received ID code to each of the internal ID codes; and
a switch switching to one of the SIM cards with the service provider identified by the received ID code is recognized as the direct provider of the SIM card switched to, identified by the corresponding internal ID code.

9. The apparatus as claimed in claim 8 wherein the internal ID codes further identify a compatible service provider of the SIM cards.

10. The apparatus as claimed in claim 9 wherein:
the storage device stores a priority table comprising priorities of cooperation for the SIM cards with the compatible service provider; and
the switch switches to one of the SIM cards according to the priorities when the service provider identified by the received ID code is recognized as the compatible one of the SIM cards switched to, identified by the corresponding internal ID code.

11. The apparatus as claimed in claim 10 wherein the priorities correspond to fee rates under the cooperation between the SIM cards with the compatible service provider and the fee rate of the cooperation for the SIM card switched to with the compatible service provider is the lowest.

12. The apparatus as claimed in claim 8 wherein the switching of the SIM cards is activated immediately after the telephone is turned on.

13. The apparatus as claimed in claim 8 wherein the switch is a multiplexer.

14. The apparatus as claimed in claim 8 wherein the telephone comprising a Send key and the switching of the SIM cards is activated immediately after the Send key is pressed.

15. The method as claimed in claim 15 wherein the priorities correspond to fee rates of the cooperations of the SIM cards with the compatible service provider and the fee rate of the cooperation of the SIM card switched to with the compatible service provider is the lowest.

16. A method for switching between multiple SIM cards within a telephone, comprising the steps of:
Storing a plurality of internal ID codes identifying at least one service provider of the SIM cards;
Storing a priority table comprising priorities of cooperation for the SIM cards with the service provider;
Receiving an ID code identifying the service provider; and
Switching to one of the SIM cards according to the priorities of the cooperation with the service provider.
